(19) United States
(12) Patent Application Publication
(10) Pub. No.: US 2005/0213786 A1
(43) Pub. Date: Sep. 29, 2005

(54) Acoustic system for vehicle and corresponding device

(75) Inventor: Yvon Kerneis, Guipavas (FR)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Cabasse, Plouzane (FR)

(21) Appl. No.: 11/033,990

(22) Filed: Jan. 12, 2005

(30) Foreign Application Priority Data
Jan. 13, 2004 (FR) 04/00274

(51) Int. Cl. H04R 5/02

(52) U.S. Cl. 381/302

(57) ABSTRACT

The invention relates to an acoustic system for a vehicle including at least one source adapted to produce a source sound signal and at least one set of at least two speakers, each of the speakers being adapted to produce a sound signal associated with it. The system further includes a filter making at least two separate filtering operations of the source signal to output at least two sound signals each associated with at least one of the speakers, such that they are approximately coherent in phase and in amplitude when perceived by at least one of the listeners positioned in a predetermined location.

### DOMAIN OF THE INVENTION

The invention relates to the domain of sound and audio and more precisely, the invention relates to devices and systems intended for transport vehicles and/or displacement of persons (particularly automobiles, heavy good vehicles, aircraft, boats, trains).

### SOLUTIONS ACCORDING TO PRIOR ART

Traditionally, automobile vehicles are equipped with car radios connected to speakers located in a dashboard, in doors and/or at the back of the vehicle. It is usually possible to balance (fade) the power output by the different speakers firstly between the front and the back, and secondly between the left and the right. A subwoofer is sometimes added in the boot of the vehicle. Nevertheless, the stereophonic image output by the speakers is not optimum and remains difficult to control.

Thus, FIG. 1 illustrates an acoustic system for a vehicle known in itself and that comprises:
a car radio 11;
mid-range and treble speakers 12 and 13 (with a cut-off frequency of 5 kHz) with a relatively narrow pass band, located on the left and right sides respectively of the vehicle dashboard and in the doors;
mid-range and treble speakers 16 and 17 located on the left and right sides of the vehicle rear parcel shelf respectively; and
a subwoofer 14 located at the back of the vehicle.

Typically, the front speakers include 13 or 17 cm mid-range speakers installed in the bottom of the doors, separated by a distance of more than one metre and associated with a tweeter installed in the dashboard. The car radio 11 includes a sound source 111 controlled by a man/machine interface 110 that in particular controls the source itself, the output sound volume and the fader, and outputs a sound signal on five channels to an interface 112.

The interface 112 powers each of the speakers 12, 13, 14, 16 and 17 separately through connections 121, 131, 141, 161 and 171.

The speakers are approximately omnidirectional such that two persons (for example the driver and the passenger) can correctly hear the sound produced by the five speakers 12, 13, 14, 16 and 17. However, the sound (that propagates along a direction represented by the dashed lines) produced by these speakers is reflected many times in the passenger compartment, resulting in a diffused sound image. Therefore, it is impossible for a listener to have a good stereophonic image even if he can control the volume output by each of the speakers using the fader. Furthermore, the cut-off frequency is 5 kHz between the mid-range speakers which corresponds to a wavelength of the order of 6.8 cm, which is very low compared with the distance between the speakers and which therefore prevents good coherence in the reproduction of sound sources.

### PURPOSES OF THE INVENTION

The various aspects of the invention all have the objective of overcoming these disadvantages according to prior art.

More precisely, one purpose of the invention is to provide an acoustic system for a vehicle that improves the stereophonic listening quality while maintaining a good spectral equilibrium.

Another purpose of the invention is to improve the reproduction of the sound relief produced by the speakers.

Another purpose of the invention is to provide listening quality adapted to each passenger in a vehicle.

Yet another purpose of the invention is to provide a sound source with spatial coherence (particularly in the treble range, the directivity of the source increasing progressively towards treble frequencies) with limited and well-controlled reflection effects on the vehicle compartment.

Another purpose of the invention is to enable relatively easy implementation of the acoustic system.

### ESSENTIAL CHARACTERISTICS OF THE INVENTION

The invention proposes an acoustic system for a vehicle to achieve this purpose including:
at least one source adapted to produce a source sound signal;
at least one set of at least two speakers, each of the speakers being adapted to produce a final sound signal associated with it; and
at least one predetermined location in which at least one listener will be positioned; each location being associated with a given set of at least two speakers;

the system being remarkable in that for at least one given location, the associated set includes at least one pair of speakers called the right and left speakers, that are positioned approximately symmetrically with respect to the said given location,

and in that the system also includes filtering means making at least two separate filtering operations of the source signal to output at least two filtered sound signals each activating one of the right and left speakers, such that the final sound signals produced for the right and left speakers are approximately coherent in phase and in amplitude when perceived by a listener positioned in the said given location.

Thus, the filtering means act simultaneously on the sound signals associated with speakers. Filtering creates a sound field at the listener's ears similar to what he would perceive in a concert hall. To achieve this, the filtering means act on two important parameters associated with spatialization perceived by the two ears of the listener:
the amplitude difference (or level); and
the time difference (or time-lag).

In particular, a listener immersed in a sound field (for example a concert hall) perceives a phenomenon corresponding to the special nature of his ears and his auditory perception system; a front sound scene that he hears by direct sound, in which he can distinguish different musical instruments precisely; in this case, the information is captured by the two ears in the form of an amplitude and time difference on the signals received by the two ears. A multi-channel source (particularly with two, three, five or seven channels) filtered on each channel according to the invention, can reproduce sound spatialization in a vehicle.

According to one particular characteristic, the system is remarkable in that the filtering means include means of reproducing a virtual sound image in three dimensions at the positions of listeners in a predetermined location, starting from sound signals each associated with at least one of the speakers.

A listener located in a vehicle is usually in a predetermined fixed position. Sound filters associated with speakers and adapted to good spatialization of the sound are thus used as a function of the position of the corresponding speakers and as a function of the position of the listener(s).

According to one particular characteristic, the system is remarkable in that the filtering means are of the head relative transfer function (HRTF) type.

An HRTF (Head Relative Transfer Function) enables a three-dimensional sound image from at least two speakers in a vehicle type environment while remaining relatively simple to use.

According to one particular characteristic, the system is remarkable in that at least one of the sources comprises at least two channels and in that each of the filtering operations is applied to one of the channels.

Thus, for a multi-channel source, for example with two, three, five or seven channels, each of the channels is filtered in a special manner.

According to one particular characteristic, the system is remarkable in that at least one of the sets comprises at least one pair of speakers called the left and right speakers, that are positioned approximately symmetrically with respect to a predetermined location with which the pair is associated, filtering means making at least two separate filtering operations on the source signal to output at least two sound signals each associated with the left and right speakers, such that the associated sound signals are approximately coherent in phase and in amplitude when they are perceived by a listener located at the predetermined location.

Thus, the use of filtering means is facilitated in a two-channel sound environment, the signals intended for the right and left speakers in a given pair not requiring phase or amplitude correction associated with an asymmetry of their position with respect to a listener.

According to one particular characteristic, the system is remarkable in that at least one of the sets comprises at least one pair of speakers called the left and right speakers, that are positioned approximately non-symmetrically with respect to a predetermined location with which the pair is associated, and in that the system comprises means of shifting the phase and modifying the amplitude of signals, each associated with right and left speakers and intended to compensate for lack of symmetry in the position of the left and right speakers with respect to the predetermined location, such that the associated sound signals are approximately coherent in phase and in amplitude when they are perceived by a listener placed at a predetermined location.

Thus, in a two-channel system, the use of filtering means is compatible with non-symmetric positioning of the right and left speakers with respect to the position of a listener, for example when non-symmetric pre-wiring is installed in the vehicle or when there are fewer speakers.

According to one particular characteristic, the system is remarkable in that at least two of the speakers are located in a dashboard of the vehicle.

Thus, the system enables good listening quality for listeners in the front of the vehicle while enabling a simple and efficient installation, the speakers preferably being positioned close to the system control means. This positioning also enables optimisation of the space available in the passenger compartment.

According to one particular characteristic, the system is remarkable in that at least two of the speakers are located in a seat of the vehicle.

Thus, the system also enables good listening quality for listeners behind a seat in which a pair of speakers according to the invention is installed while optimising the ergonomy of the vehicle and the use of space available in the passenger compartment.

According to one particular characteristic, the system is remarkable in that at least two of the speakers are associated with a removable support.

Thus, installation and use of the system are particularly simple and adaptable to different types of vehicles.

According to one particular characteristic, the system is remarkable in that it includes means of dynamic tuning of the filtering means as a function of the position of the listener(s).

Thus, the characteristics of filters and speaker controls (speakers can be cut off, for example if a listener position is not occupied) are optimised as a function of the position of the listeners within the vehicle.

According to one particular characteristic, the system is remarkable in that it includes means of selecting the position of the listener(s).

Thus, the position of the listener(s) may be determined manually (for example, the listener(s) selecting an operating mode of the system as a function of predetermined positions) or automatically (for example, taking account of information output by seat sensors and/or safety belt sensors used in vehicles). The characteristics of filters are then dynamically adapted as a function of the selected positions.

According to one particular characteristic, the system is remarkable in that it includes means of automatic identification of the position of the listener(s).

According to one particular characteristic, the system is remarkable in that at least two of the speakers are directional.

Thus, sounds are approximately direct and are not much reflected by the environment such that the listener(s) are not much disturbed by echoes in the passenger compartment or sound produced by speakers associated with other passengers in the vehicle.

According to one particular characteristic, the system is remarkable in that the filtering means include at least two finite impulse digital filters each generating sound signals associated with speakers.

According to one particular characteristic, the system is remarkable in that at least one of the speakers is of the coaxial type with counter motor.

Thus, the size of the speakers is limited, the coaxial motors with counter motor having a wide pass band (particularly covering mid-range and treble frequencies). Therefore they can easily be installed in a vehicle, particularly in a seat or in a dashboard at a relatively small spacing.

According to one particular characteristic, the system is remarkable in that the source belongs to the group including:
radio tuners;
players for pre-recorded sound media;
computers;
game consoles; and
electronic terminals.

According to one particular characteristic, the system is remarkable in that the vehicle belongs to the group including:
automobiles;
aircraft; and
trains.

The invention also relates to a device for a vehicle designed to be associated with an acoustic system that includes:
at least one source adapted to produce a source sound signal;
at least one set of at least two speakers, each of the speakers being adapted to produce a final sound signal associated with it; and
at least one predetermined location in which at least one listener will be positioned, each location being associated with a given set of at least two speakers;

that is remarkable for a given location, the associated set includes at least one pair of speakers called the right and left speakers, that are positioned approximately symmetrically with respect to the said given location,

and in that the device also includes filtering means making at least two separate filtering operations of the source signal to output at least two filtered sound signals each activating one of the right and left speakers, such that the final sound signals produced for the right and left speakers are approximately coherent in phase and in amplitude when perceived by a listener positioned in the said given location.

The advantages of the device are the same as the advantages of the acoustic system for a vehicle, and will not be described in more detail.

### LIST OF FIGURES

Other characteristics and advantages of the invention will become clearer after reading the following description of a preferred embodiment, given as a simple illustrative and non-limitative example and the attached drawings, among which:

FIG. 1 shows an acoustic system for a vehicle known in itself;

FIG. 2 diagrammatically shows an acoustic system for a vehicle according to a particular embodiment of the invention;

FIG. 3 diagrammatically shows an acoustic system for a vehicle according to one variant of the invention;

FIGS. 4 to 7 illustrate particular locations of the speakers according to the system illustrated with reference to FIG. 2; and

FIG. 8 shows a speaker particularly well adapted to the acoustic systems in FIGS. 2 and 3.

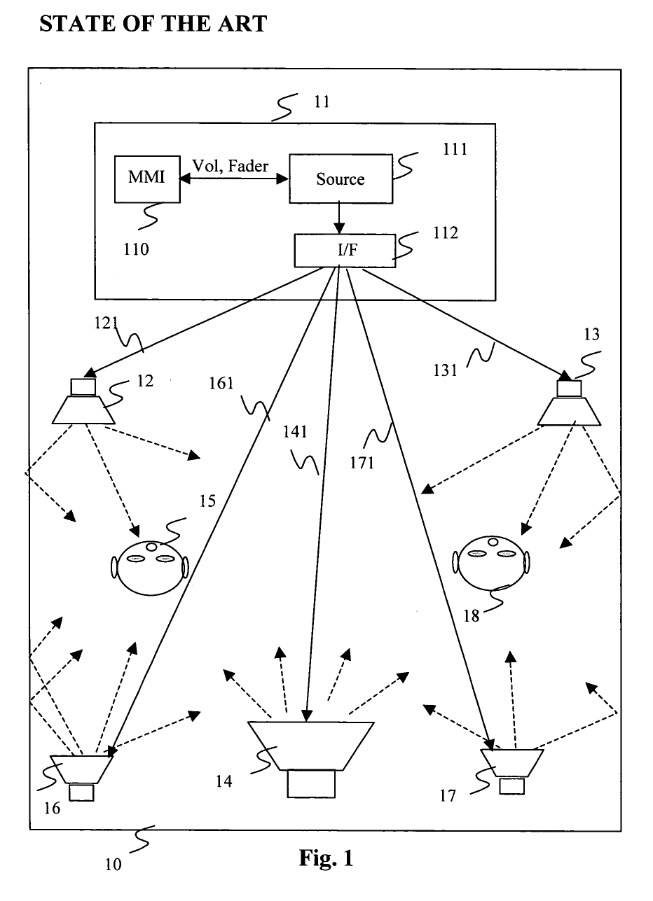

### DESCRIPTION OF ONE EMBODIMENT OF THE INVENTION

The general principle of the invention is based on an acoustic system comprising two speakers positioned and/or configured such that a listener perceives mainly an approximately coherent sound (in other words well balanced in phase and in amplitude) and preferably directly output from each of these speakers. Thus, the sound image output to the listener is very good quality. Preferably, the speakers intended to be heard by a listener are placed facing this listener approximately symmetrically. Nevertheless, if the speakers are not positioned symmetrically, according to the invention the phase and the amplitude are controlled at each speaker such that the listener perceives approximately coherent corresponding sound signals.

According to one preferred characteristic, the source device comprises means of powering each of these speakers in order to reproduce a virtual sound image in three dimensions at the listener, particularly for mid-range and treble frequencies. For example, these means enable processing of the sound signal to power the speakers with an HRTF (Head Relative Transfer Function) type signal. This type of technique (used in multimedia systems according to the state of the art in an office or home environment), can provide a three-dimensional sound image according to the invention from two speakers in a vehicle type environment.

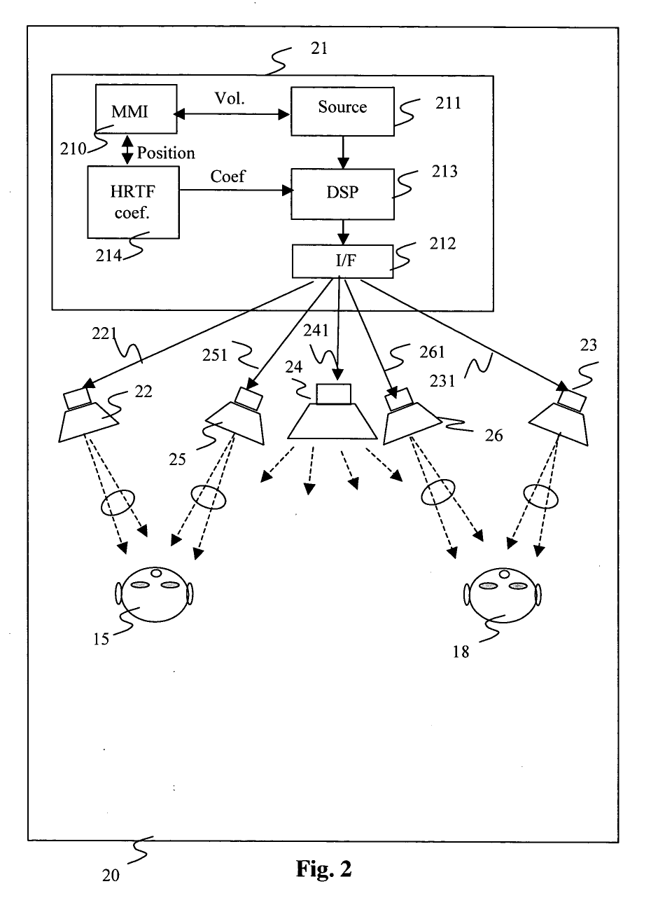

We will now describe one embodiment of an acoustic system according to the invention, with reference to FIG. 2.

The acoustic system is installed in a vehicle passenger compartment 20 (for example an automobile) and comprises:
a sound generation device 21;
mid-range and treble speakers 22 and 25 located on the vehicle dashboard, practically facing a corresponding listener 15 (for example the vehicle driver) and slightly to the left and right of the listener 15 respectively, and approximately symmetric with respect to the listener;
mid-range and treble speakers 26 and 23 located on the vehicle dashboard, practically facing a corresponding listener 18 (for example a passenger of the vehicle) and slightly to the left and right of the listener 18 respectively and approximately symmetric with respect to the listener; and
a subwoofer 24.

The treble and mid-range speakers 22, 25, 26 and 23 preferably have a fairly narrow sound diffusion cone (in other words, the speakers 22, 25, 26 and 23 are relatively directional) and are directed towards the corresponding listener 15 or 18. Thus the listeners clearly hear the treble and mid-range speakers associated with them and are not much disturbed by the other speakers (for example the listener 15 will clearly hear the speakers 22 and 25 without being disturbed by speakers 26 and 23).

Considering the wavelengths of bass tones that are relatively long compared with the vehicle dimensions, the subwoofer 24 is preferably omnidirectional and is placed at the front of the vehicle to produce a sound for all passengers in the vehicle.

According to one variant of the invention not shown, the speakers 22, 25, 26 and 23 also produce bass tones.

The device 21 comprises:
a sound source 211 (for example such as a radio, tape player, disk player, television set, etc.);
a man/machine interface 210;
an HRTF coefficients determination unit 214;
a Digital Signal Processor (DSP) 213; and
an output interface 212.

The man/machine interface 210 is used particularly to control the source 211 itself (source type, radio frequency, disk track, etc.). It is also used to control the unit 214 particularly by defining the position of the listener(s) and the volume of each of the speakers associated with a particular listener.

The unit 214 transmits coefficients from an HRTF filter to the DSP 213, in order to output a 3D sound image for each of the listeners 15 and 18. These coefficients are preferably determined as a function of the vehicle and the position of the passengers and are pre-recorded in unit 214. According to one variant, the unit 214 dynamically calculates the value of these coefficients.

Then, the DSP 213 that performs the corresponding filtering operation on the sound signal for each of the channels connected to speakers 22 to 26 through the interface 212 and the corresponding connections 221, 251, 261, 231 and 241.

In general, an HRTF filter comprises two finite impulse response digital filters (FIR) with N coefficients generating the following from a source signal X(n):
a signal to a left speaker YL(n); and
a signal to a right speaker YR(n).

Thus, the left and right filters are characterised by coefficients HL(i) and HR(i) respectively, where i varies from 1 to N. An HRTF transfer function is defined as being a particular frequency response for the right ear or the left ear, measured between a speaker and a specific point on the auditory canal.

The HRTF transfer function is measured using coefficients of the transfer function (or left and right filters) as a function of the vehicle passenger compartment, the position of the speakers and the position of the listener(s), and is used to design the filters. Preferably, the listener in the vehicle is simulated by a dummy with microphones in its ears, the dummy being positioned in the vehicle as the listener would be. The IACC (Inter Aural Correlation Coefficient) is measured from the sound signals picked up by the microphones. Thus, the IACC and therefore the degree of spatialization is measured in order to design or check the quality of the system; when the signals perceived by the right and left ears are only slightly correlated, the listener has a strong impression of spatialization. As the correlation becomes weaker, the performances of the acoustic system become better. Thus, filter parameters are optimised.

Those skilled in the art may also refer to the book entitled “3D sound for virtual reality and multimedia” (particularly chapter 4), written by Durand R. Begault and published at Academic Press, Boston in 1994 to design an HRTF filter and adapt the determination of filter coefficients to the case of vehicle passenger compartments, or patent U.S. Pat. No. 5,173,944 issued on Dec. 22 1992 entitled “Head related transfer function pseudo-stereophony” invented by M. Begault.

The YL(n) and YR(n) signals at time n are determined by the following relations:

$$YL ( n ) = {\sum }_{i - 0}^{N - 1} HL ( n - i ) \cdot X ( n - i )$$

$$and YR ( n ) = {\sum }_{i - 0}^{N - 1} HR ( n - i ) \cdot X ( n - i )$$

The filter coefficients are preferably pre-recorded.

According to one variant of the invention, the HRTF filter includes two infinite impulse response (IIR) digital filters.

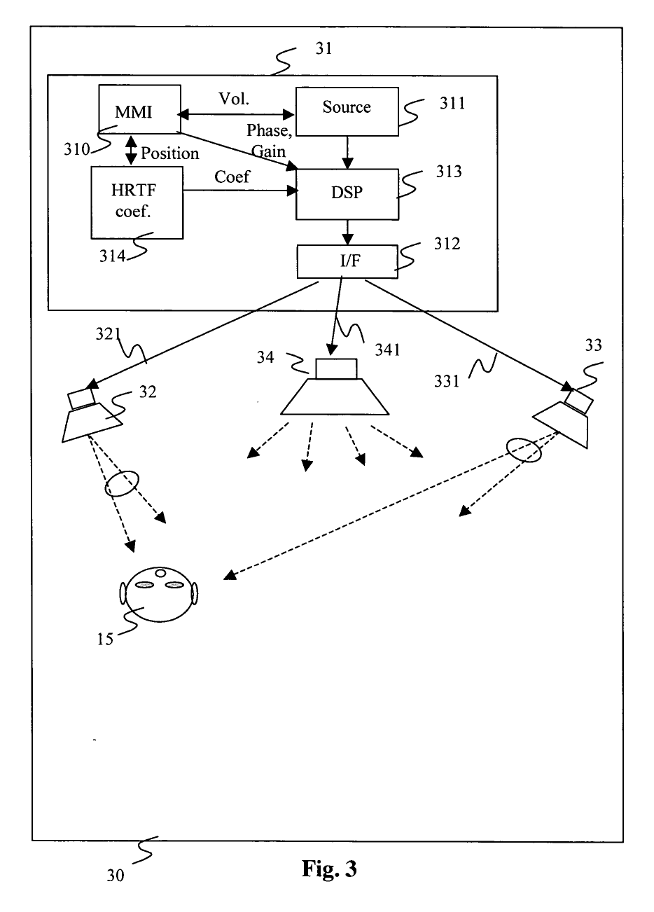

FIG. 3 diagrammatically presents an acoustic system for a vehicle according to one variant of the invention.

The acoustic system is installed in a vehicle passenger compartment 30 (for example an automobile) and comprises:
a sound generation device 31;
mid-range and treble speakers 32 and 33 located on the vehicle dashboard, on the left side and the right side respectively of the dashboard, not approximately symmetrical with respect to a listener 15 (for example the vehicle driver), for example on the left side of the passenger compartment 30; and
a subwoofer 24.

The treble and mid-range speakers 32, 33 and 34 preferably have a fairly wide sound diffusion cone and are therefore more omnidirectional. They are not necessarily aimed towards the listener 15.

The device 31 comprises:
a sound source 311 similar to the source 211 illustrated above;
a man/machine interface 310;
an HRTF coefficients determination unit 314;
a Digital Signal Processor (DSP) 313; and
an output interface 312.

In the same way as the interface 210, the man/machine interface 310 is used particularly to control the source 311 itself controlled from unit 314. The man/machine interface 310 also enables operation in two distinct modes:
according to a first operating mode, the HRTF filter is active and enables an optimum sound image aimed preferentially at one listener; and
according to a second operating mode, the HRTF filter is deactivated and enables standard stereo listening on speakers 32, 33 and 24, particularly well adapted to listening by several listeners,

In the first operating mode, a listener or a position sensor indicates the position of the listener to the interface 310 (for example position of the passenger or the driver corresponding to pre-recorded positions as a function of the seats in the vehicle or dynamic adjustment that the listener refines as a function of the sound reproduction). The interface 310 then determines the amplitude and phase difference to be applied to each of the speakers 32 and 33 such that the sound signals produced by these two speakers arrive at the listener's ears coherently (in other words without phase shift or amplitude difference). The difference in amplitude (or gain) G and the time-lag τ to be applied depend on the difference between the distances Δd separating the listener from each of the speakers according to the following relations:
G=kΔd² where ΔG=20 log Δd (in dB); and
τ=Δd/c where c is the speed of sound.

Thus, if the distances between the listener 15 and the speakers 32 and 33 are equal to 0.5 m and 1.5 m, Δd is equal to 1 m and the gain to be applied to the speaker 33 is about 9.5 dB and the time-lag is equal to about 3 ms.

The unit 314 calculates the coefficients of an HRTF filter to supply a 3D sound image for the listener 15 (for example) and outputs these coefficients to the DSP 313 that performs the corresponding filter operations on the sound signal, the phase shift and amplitude difference for each of the channels connected to the speakers 32, 33 and 34 through the interface 312 and the corresponding connections 321, 331 and 341.

Thus, according to the embodiment of the invention illustrated with reference to FIG. 3, the device 31 enables compatibility with stereo systems including two speakers or with vehicles pre-equipped with speakers on each side of the vehicle while enabling optimisation of the sound image in three dimensions when the number of persons inside the vehicle is small.

More generally, this embodiment enables a reduction in the number of necessary speakers.

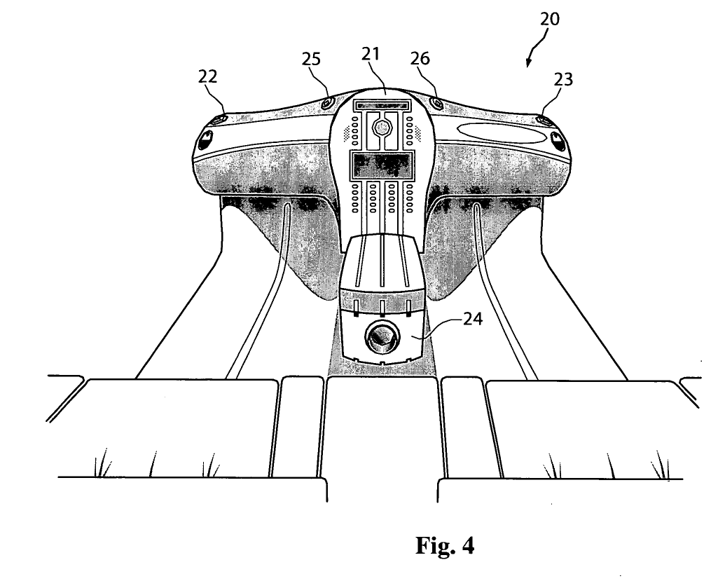

FIG. 4 illustrates a particular embodiment of the acoustic system of the passenger compartment 20 illustrated with reference to FIG. 2.

The passenger compartment 20 comprises a dashboard that itself includes:
the device 21 at its centre, so that a listener can easily access it and control it;
speakers 22 and 25 for the driver, that are symmetrically located on each side of the steering wheel (assumed to be at the left for illustrative purposes); and
speakers 26 and 23 located symmetrically with respect to a passenger, if there is one.

The subwoofer 24 is located between the seats near the bottom of the passenger compartment.

According to one variant, the speakers 22, 25, 26 and 23 are located at a high level (for example above the windshield), but are positioned symmetrically with respect to the listener corresponding to them.

According to another variant, the subwoofer 24 is located in the vehicle boot.

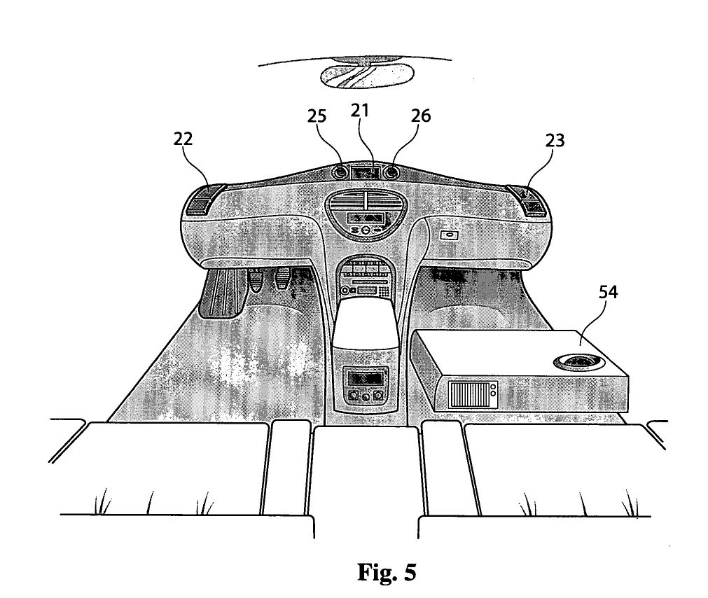

According to another variant illustrated in FIG. 5, there is a subwoofer 54 under the passenger seat.

Furthermore, the acoustic system illustrated with reference to FIG. 5 is similar to that in FIG. 4, and the common elements are marked with the same references and will not be described further.

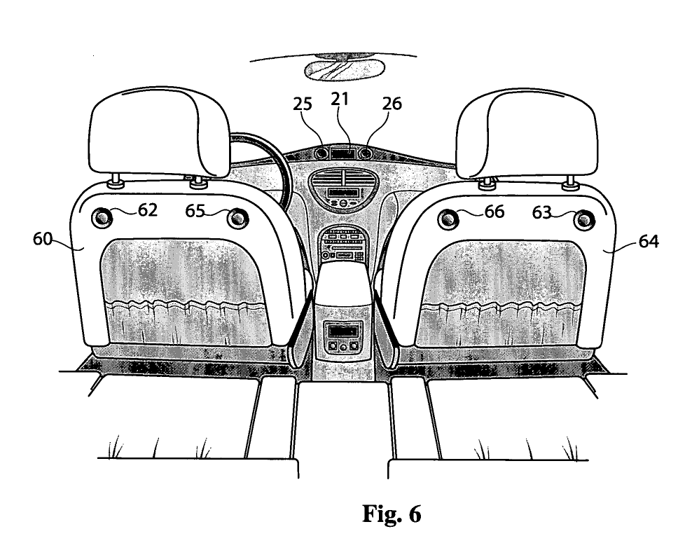

FIG. 6 shows a vehicle equipped with an acoustic system corresponding to FIGS. 2 and 4, the vehicle being seen from the positions reserved to passengers at the back of the vehicle.

The passenger compartment 20 includes two front seats 60 and 64 fitted with two speakers on each side of their corresponding back face in their top part.

Thus, the seat 60 (or 64) is fitted with two fixed speakers 62 and 65 (or 66 and 63) for use by a back seat passenger located at the left (or right) of the passenger compartment 20. Each of these speakers is connected to the interface 212 and emits a sound signal similar to that produced by the speakers 22 and 25, thus producing a virtual sound image in three dimensions for the corresponding listener.

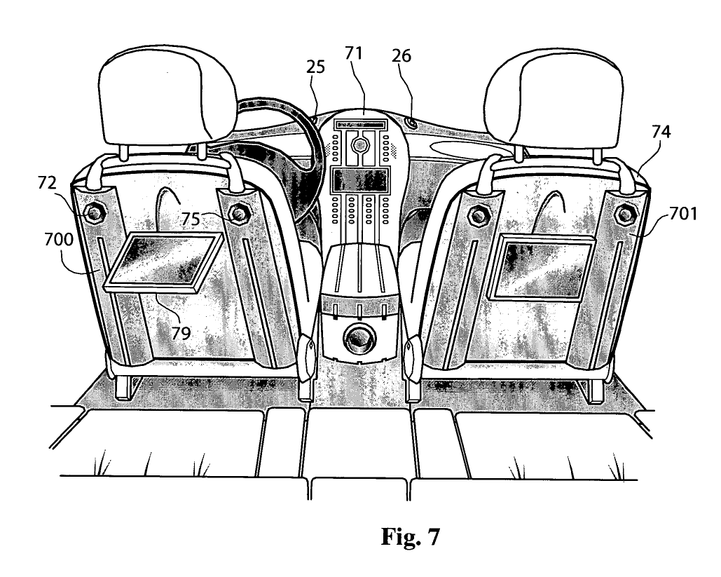

FIG. 7 presents the back of a vehicle equipped with an acoustic system corresponding to FIGS. 2 and 5.

Moreover, the passenger compartment 20 comprises two front seats 70 and 74 each provided with a removable device 700 or 701.

The device 700 comprises:
means of fastening onto the base of a headrest of the seat 70;
a television and/or computer flat screen 79 located on the back of the seat 70; and
a pair of directional speakers 72 and 75 located on each side of the device, also on the back of the seat 70 and oriented towards a back seat passenger, if any, sitting behind the seat 70.

The device 701 is similar to the device 700 and therefore will not be described further.

The two speakers are connected to a device 71 similar to the device 21 also with means of simultaneously managing several independent sources and particularly:
a car radio or CD player;
a first electronic terminal (for example a computer, a games console) and/or a television tuner associated with the screen 79;
a second electronic terminal and/or television tuner associated with the screen of device 701.

The means of simultaneously managing several sources are particularly adapted to differentiating these sources, to amplifying, filtering (using an HRTF mode) and switching the sound signals produced towards one or several pairs of corresponding speakers (left and right) as a function of user choices made using control means (for example selection buttons). The means of simultaneously managing several sources may include several DSP amplification and filtering circuits. According to one variant, these means include a single DSP that is sufficiently powerful to process several independent input and output signals simultaneously.

Preferably, the devices 700 and 701 are independent and are adapted to produce a different image and sound on their screen and the corresponding speakers, from a different source. According to this embodiment of the invention, the sound image created by devices 700 and 701 is located in an area behind the seats in which they are positioned. Thus, the sound from device 700 covers the sound produced by the device 701 within an area behind the seat 70 (or 74). Thus, a passenger behind seat 70 will not be disturbed by sound produced by device 701 (or not disturbed very much), even if the speakers 73 and 76 of the device 701 are not connected to the same source as the speakers 72 and 75 of the device 700 (since the device 71 is adapted to transmit independent signals on each of the pairs of speakers). On the other hand, he will perceive a good quality three-dimensional sound image produced by the speakers 72 and 75.

According to one embodiment, the sound amplification and filtering device is adapted to process a signal output from a single source; according to this variant, each of the pairs of speakers reproduces a similar sound image in three dimensions corresponding to this source with an identical filter for each of the pairs of speakers, and with a simple differentiation between the left and right speakers. Thus, the amplification and filtering device is relatively easy to use with this variant.

According to another variant embodiment, the sound amplification and filtering device is adapted to process a signal output from a single source and comprises filtering means specific to each pair of speakers as a function of the corresponding listeners if any.

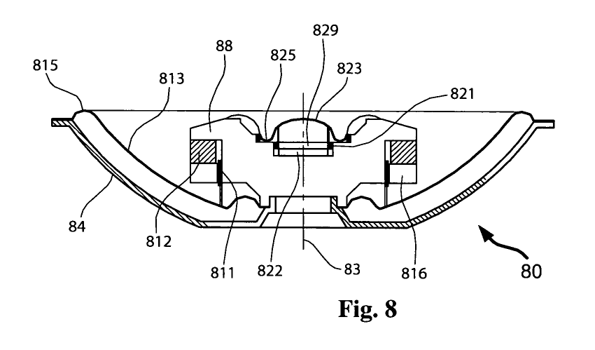

FIG. 8 presents a coaxial speaker with a counter motor particularly well adapted to acoustic systems in FIGS. 2 to 7, and for example corresponding to mid-range and treble speakers 22, 23, 25, 26, 32, 33, 62, 63, 65, 66, 72 and 75.

The speaker 80 is approximately symmetrical in the axial direction about a centre line 83 and it includes the following elements installed on the same centre line 83:
ma chassis 84;
a cylindrical yoke 88 placed on the centre line of the speaker 80;
a first mid-range production set (for example 500 Hz to 5 kHz) comprising a membrane 813, a magnet 812, a field plate 816 and a coil 811 fixed to the membrane 813; and
a second treble production set (for example 5 kHz to 20 kHz) comprising a membrane 823, a magnet 822, a field plate 829, a coil 821 fixed to the membrane 823 and a foam dome placed under the membrane 823 and designed to dampen vibrations of this membrane (and therefore to make the response curve of the speaker 80 more uniform in the trebles).

The magnets and the field plates are fixed to the chassis 84. The magnets are rare earth magnets (for example of the Neodymium—Iron—Boron (or NdFeB) or Samarium—Cobalt type. The coils can move along the centre line 83 inside a magnetic field created by the field plate and the magnet in their corresponding production set.

The outside diameter of the membrane 813 is about 6 cm, and it is flexibly fixed to the chassis 84 through peripheral and central suspensions 815. The outside diameter of the membrane 823 is about 2 cm and it is flexibly fixed to a peripheral support itself rigidly fixed to the yoke 88 through a peripheral suspension 825. These diameters may be much larger or smaller depending on the variants of the invention and as a function of the required sound frequencies. The mid-range membrane 813 is concave as seen from the outside of the speaker 80. The trebles membrane 823 is convex.

The depth of the speaker 80 is about 3 cm.

Thus, the size of the speaker 80 is reduced to facilitate placement in a dashboard or in a seat of the vehicle; in particular, the size is reduced due to membranes 813 and 823 located inside the chassis 84 and with a coaxial and counter speaker motor.

According to other embodiments, the speaker is a coaxial speaker with a counter motor and with a concave mid-range membrane, the trebles production set is then preferably located between the chassis and the mid-range membrane.

The frequency response of the sound production sets is determined by the shapes and dimensions, according to rules known to those skilled in the art. Preferably, currents supplying power to coils 811 and 821 are filtered in frequency (preferably independently from HRTF filtering) so that the acoustic response of the speaker 80 is as constant as possible in the band considered (for example 500 Hz to 20 kHz) such that the sound production is good quality.

According to other variants of the invention, the speaker is coaxial without a counter motor.

Obviously, the invention is not limited to the example embodiments mentioned above.

In particular, those skilled in the art could add any variant of any type (finite or infinite impulse response filter applied to a time or frequency signal) and characteristics (number of coefficients, quantification, sampling frequency, etc.) of HRTF filters.

Obviously, the invention is compatible with any type of stereo source, particularly with two channels or more generally multi-channel (for example the number of channels varying from 2, 3, 5 or 7). Each of the channels is filtered such that the corresponding signals are approximately coherent in phase and in amplitude when they are perceived by at least one listener in a predetermined location. For example, the filter applied to each of the channels may be of the HRTF type such that the listener(s) perceive a virtual sound image in three dimensions.

Those skilled in the art could make any variant in the sound spectrum of the speakers according to the invention (for example frequency range from 200 Hz to 20000 Hz or from 50 to 1000 Hz or 50 to 20000 Hz).

For example, the mid-range and treble speakers according to the invention may be of the coaxial type or may be separated into distinct elements.

The invention relates to audio systems from any source particularly such as a radio tuner, a player of a recorded medium (CD Audio, DVD, etc.) or any type of terminal (computer, games console, etc.).

The filtering means according to the invention include means of determining filter coefficients and signal processing means for filtering itself, and are used in any device adapted to use in a vehicle, particularly in the form of special purpose equipment (interfacing a sound source and speakers) or integrated into a source type equipment (for example car radio) or speaker or in the form of a module (with several components) or an isolated component, a processor associated with a program containing filtering instructions, program containing instructions to filter a sound signal intended for a vehicle.

Those skilled in the art could also make any variant to the position of pairs of speakers to be used by a listener; in particular, these pairs of speakers could be used on vehicle dashboards, seats, elbow rests, the vehicle ceiling, doors, etc.

The invention also relates to equipment using speakers according to the invention, particularly loudspeaker enclosures, headsets, seats or dashboards of vehicles, audio equipment, video equipment and/or multimedia making use of such speakers.

The invention is applicable to all vehicles, particularly such as automobiles, aircraft, boats or heavy goods vehicles, including an acoustic system like that described above according to the invention and/or means of integrating such a system.

1. Acoustic system for a vehicle comprising:
at least one source adapted to produce a source sound signal;
at least one set of at least two speakers, each of the said speakers being adapted to produce a final sound signal associated with it; and
at least one predetermined location in which at least one listener will be positioned; each location being associated with a given set of at least two speakers;
characterised in that, for at least one given location, the associated set includes at least one pair of speakers called the right and left speakers, that are positioned approximately symmetrically with respect to the said given location,
and in that the system also includes filtering means making at least two separate filtering operations of the source signal to output at least two filtered sound signals each activating one of the right and left speakers, such that the final sound signals produced for the right and left speakers are approximately coherent in phase and in amplitude when perceived by a listener positioned in the said given location.

2. System according to claim 1, the said system being of the type including at least two predetermined locations in which at least one listener will be positioned, each location being associated with a given set of at least two speakers, characterised in that, for each of the said locations, the associated set comprises at least one pair of speakers called the right and left speakers, that are positioned approximately symmetrically with respect to the said location, and in that the said at least two filtered sound signals activate the right and left speakers of each of the said associated sets at the predetermined locations.

3. System according to claim 1, characterised in that the said filtering means include means of reproducing a virtual sound image in three dimensions at the position of the said listener(s) in the said predetermined location(s), starting from the said final sound signals produced by the right and left speakers of each of the said sets associated with the locations.

4. System according to claim 3, characterised in that the said filtering means are of the head relative transfer function (HRTF) type.

5. System according to claim 1, characterised in that at least one of the said sources comprises at least two channels and in that each of the said filtering operations is applied to one of the said channels.

6. System according to claim 1, characterised in that at least two of the said speakers are located in a dashboard of the said vehicle.

7. System according to claim 1, characterised in that at least two of the said speakers are located on a seat of the said vehicle.

8. System according to claim 1, characterised in that at least two of the said speakers are associated with a removable support.

9. System according to claim 1, characterised in that it includes means of dynamic tuning of the said filtering means as a function of the position of the listener.

10. System according to claim 9, characterised in that it includes means of selecting the position of the listener.

11. System according to claim 9, characterised in that it includes means of automatic identification of the position of the listener.

12. System according to claim 1, characterised in that at least two of the said speakers are directional.

13. System according to claim 1, characterised in that the said filtering means include at least two finite impulse digital filters each generating sound signals associated with speakers.

14. System according to claim 1, characterised in that at least one of the said speakers is of the coaxial type with counter motor.

15. System according to claim 1, characterised in that the said source belongs to the group including:
radio tuners;
players for pre-recorded sound media;
computers;
game consoles; and
electronic terminals

16. System according to claim 1, characterised in that the said vehicle belongs to the group including:
automobiles;
aircraft; and
trains.

17. Device for vehicle designed to be associated with an acoustic system, the said system including:
at least one source adapted to produce a source sound signal;
at least one set of at least two speakers, each of the said speakers being adapted to produce a final sound signal associated with it; and
at least one predetermined location in which at least one listener will be positioned, each location being associated with a given set of at least two speakers;
characterised in that, for a given location, the associated set includes at least one pair of speakers called the right and left speakers, that are positioned approximately symmetrically with respect to the said given location,
and in that the device also includes filter making at least two separate filtering operations of the source signal to output at least two filtered sound signals each activating one of the right and left speakers, such that the final sound signals produced for the right and left speakers are approximately coherent in phase and in amplitude when perceived by a listener positioned in the said given location.
